(19) United States
(12) Patent Application Publication
(10) Pub. No.: US 2026/0212467 A1
(43) Pub. Date: Jul. 23, 2026

(54) OPTIMIZED RASTER SCAN CORRECTION ENGINE

(71) Applicant: QUALCOMM Incorporated, San Diego, CA (US)

(72) Inventors: Bhupinder Singh PARHAR, Escondido, CA (US); Ganghee LEE, San Diego, CA (US); Mahdi SHAGHAGHI, San Diego, CA (US); Eric LUTZ, San Diego, CA (US); Anil Kumar GOKAVARAPU, San Diego, CA (US); Nicolas ANTOINE, La Jolla, CA (US)

(21) Appl. No.: 19/034,392

(22) Filed: Jan. 22, 2025

(51) Int. Cl. G06T 5/80; G02B 27/01; G06F 3/0346; G06T 1/20; G06T 7/20; G06T 7/70

(52) U.S. Cl. CPC G06T 5/80; G02B 27/0172; G06F 3/0346; G06T 1/20; G06T 7/20; G06T 7/70

(57) ABSTRACT

This disclosure provides systems, devices, apparatus, and methods, including computer programs encoded on storage media, for determining a raster scan correction for geometric correction. A raster scan correction engine may obtain an indication of a set of reprojection distortions. The raster scan correction engine may obtain an indication of a set of raster scan correction instructions. The raster scan correction engine may obtain either indication from at least one of a central processing unit (CPU) or a digital signal processor (DSP). The raster scan correction engine may determine a raster scan correction based on the set of reprojection distortions and the set of raster scan correction instructions. The raster scan correction engine may output an indication of the determined raster scan correction. The raster scan correction engine may output the indication to at least one of a graphics processing unit (GPU) or a geometric correction engine.

### TECHNICAL FIELD

The present disclosure relates generally to processing systems, and more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques may not address excessive power and memory wastage used by devices to determine a distortion grid for raster scan correction. There is a need for improved distortion grid calculation techniques.

### BRIEF SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include memory; at least one processor coupled to the memory and, based at least in part on information stored in the memory, the at least one processor may be configured to obtain, from a tracking unit, an indication of a predicted start head pose and a predicted end head pose. The at least one processor may be configured to obtain an indication of a representation of optical distortion. The at least one processor may be configured to determine a sparse distortion grid based on the obtained predicted start head pose, the predicted end head pose, and the representation of optical distortion. The at least one processor may be configured to output, to a geometric correction engine (GCX), an indication of the determined sparse distortion grid. The tracking unit may include a six degrees of freedom (6DOF) tracking unit. The tracking unit may include a neural signal processor (NSP). To obtain the indication of the representation of the optical distortion, the at least one processor may obtain the indication of representation of optical distortion from a memory location. The at least one processor may determine the optical distortion during a calibration of a head-mounted display (HMD) and store a representation of the optical distortion on the memory location after the determination of the optical distortion.

In some aspects, the techniques described herein relate to a method of graphics processing, including: obtaining, from a tracking unit, an indication of a predicted start head pose and a predicted end head pose; obtaining an indication of a representation of optical distortion; determining a sparse distortion grid based on the obtained predicted start head pose, the predicted end head pose, and the representation of optical distortion; and outputting, to a geometric correction engine (GCX), an indication of the determined sparse distortion grid.

In some aspects, the techniques described herein relate to a method, where the tracking unit includes a six degrees of freedom (6DOF) tracking unit.

In some aspects, the techniques described herein relate to a method, where the tracking unit includes a neural signal processor (NSP).

In some aspects, the techniques described herein relate to a method, where obtaining the indication of representation of optical distortion includes: obtaining the indication of representation of optical distortion from a memory location.

In some aspects, the techniques described herein relate to a method, further including: determining the optical distortion during a calibration of a head-mounted display (HMD); and storing a representation of the optical distortion on the memory location after the determination of the optical distortion.

In some aspects, the techniques described herein relate to a method, where the representation of optical distortion includes a display projection matrix.

In some aspects, the techniques described herein relate to a method, where the sparse distortion grid includes a reprojection matrix.

In some aspects, the techniques described herein relate to a method, where the sparse distortion grid includes a set of differences between a set of start coordinates corresponding to the predicted start head pose and a set of distorted coordinates corresponding to the predicted end head pose.

In some aspects, the techniques described herein relate to a method, where the geometric correction engine includes a set of hardened circuits to perform raster scan correction based on the determined sparse distortion grid.

In some aspects, the techniques described herein relate to a method, where determining the sparse distortion grid based on the obtained predicted start head pose, the predicted end head pose, and the representation of optical distortion includes:
determining, via a dedicated hardware unit of a system on a chip (SOC), the sparse distortion grid based on the obtained predicted start head pose, the predicted end head pose, and the representation of optical distortion.

In some aspects, the techniques described herein relate to a method, where obtaining, from the tracking unit, the indication of the predicted start head pose and the predicted end head pose includes: obtaining, from a central processing unit (CPU) including the tracking unit, the indication of the predicted start head pose and the predicted end head pose.

In some aspects, the techniques described herein relate to a method, where outputting, to a GCX, the indication of the determined sparse distortion grid includes: outputting, to a graphics processing unit (GPU) including the GCX, the indication of the determined sparse distortion grid.

In some aspects, the techniques described herein relate to a method, further including: determining a reprojection matrix based on the indication of the determined sparse distortion grid; and distorting, via the GCX, each vertex of a grid map based on the determined reprojection matrix.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example GPU in accordance with one or more techniques of this disclosure.

FIG. 3 illustrates an example image or surface in accordance with one or more techniques of this disclosure.

FIG. 4 illustrates an example of a pincushion grid and a transformed grid for raster scan correction of a virtualized frame, in accordance with one or more techniques of this disclosure.

FIG. 5 illustrates a hardware diagram of an example inverse transformation pipeline, in accordance with one or more techniques of this disclosure.

FIG. 6 illustrates a hardware diagram of an example raster scan correction engine, in accordance with one or more techniques of this disclosure.

FIG. 7 illustrates a logical diagram of an example raster scan correction engine, in accordance with one or more techniques of this disclosure.

FIG. 8 is a call flow diagram illustrating example communications between a tracking unit, a raster scan correction engine, and a graphics engine in accordance with one or more techniques of this disclosure.

FIG. 9 is a flowchart of an example method of graphics processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit.

The following description is directed to examples for the purposes of describing innovative aspects of this disclosure. However, a person having ordinary skill in the art may recognize that the teachings herein may be applied in a multitude of ways. Some or all of the described examples may be implemented in any device or system that is capable of processing graphics commands. Various aspects relate generally to reprojecting and/or composing frames for a graphics processing unit (GPU). Some aspects more specifically relate to applying reprojection fallback strategies during an excess system load (e.g., when a reprojection process for a frame will not complete in time to display the frame). For example, a graphics system may have limited dynamic random access memory (DRAM) bandwidth due to concurrent work (e.g., rendering, GPU workload, high-intensity periods of camera data acquisition), software control latencies (e.g., poorly optimized code, latencies when communicating with third-party applications), bottlenecking hardware execution, and/or power/thermal throttling. Such loads may affect the calculated projected time for a reprojection process to complete within a threshold period of time. Use of remotely rendered framebuffers (e.g., frames processed by a reprojection topology on a separate system, or a third-party system), may also affect the time to render a frame. For example, use of a second reprojection process may conserve resources if a first reprojection process uses remote-rendered framebuffers having a high calculated latency value, or if a first reprojection process uses a large amount of bandwidth (e.g., WiFi, 5G bandwidth) and a system is configured to conserve use of that bandwidth with respect to transmission/reception of remote-rendered frames.

In some aspects, a raster scan correction (RSC) engine may provide a hardware-accelerated software-defined accelerated RSC. A hardware-accelerated device may include a coprocessor that has a direct path to a computing processing unit (CPU) or a graphics processing unit (GPU). A software-defined device may include a set of programmable instructions that may be executed on specialized hardware of the device, for example a macro instruction unit, designed to perform raster scan correction-specific computations with specialized floating point units. A reprojection pre-distortion block may be configured to obtain a set of predicted head poses (e.g., a predicted start head pose, a predicted end head pose) and a representation of an optical distortion. An optical distortion may be a distortion of a planar image when displayed on a non-planar surface. The representation of optical distortion may, for example, include a pincushion grid that describes how a lens of a display (e.g., a screen of a head mounted display (HMD)) may distort a planar image. The representation of optical distortion may be used for lens distortion correction (LDC), ensuring that an image looks proportional when displayed on a non-planar surface. The representation of optical distortion may include a display projection matrix that maps vertices of a uniform grid map to vertices of a distorted grid map on a non-planar surface. The reprojection RSC engine may receive a representation of optical distortion as a pincushion grid. A reprojection RSC engine may be configured to read the head pose and compute a reprojection matrix to be applied on each vertex of a grid map. A reprojection matrix may be a matrix that translates points on a grid from initial coordinates to transformed coordinates. The reprojection matrix may take into account the head movement of a user to ensure that the reprojected frame accounts for distortion due to rolling display and head movements. The RSC engine may apply the reprojection matrix on the vertices of the distortion grid. The vertices of the distortion grid may be translated by the reprojection matrix to account for the user head movement. The firmware of the RSC engine may use the head pose to compute a perspective transformation matrix. For example, the RSC engine may apply the reprojection matrix to each vertex of a grid map, for example a pincushion grid for LDC, generating a transformed grid for both LDC and RSC. The RSC engine may have a floating point processor that applies a perspective matrix on each vertex of a grid map (e.g., a pincushion grid for LDC).

An RSC engine may obtain, from a tracking unit, an indication of a predicted start head pose and a predicted end head pose. A tracking unit may be a component that tracks head pose movement of a user of a head-mounted device, such as an HMD. The tracking unit may include, for example, a six degrees of freedom (6DOF) tracking unit that tracks the movement of a head of a user to generate a predicted head pose of the user at two points of time in the future, which may be referred to as a predicted start head pose and a predicted end head pose, where the predicted start head pose is before the predicted end head pose. In some aspects, a CPU may be configured to perform tracking of a head movement of a user to predict a starting head pose and an ending head pose of the user during a period of time in the future. In other aspects, the tracking unit may include a dedicated hardware tracking unit, such as a neural signal processor (NSP) configured to predict the head pose of the user at different points of time. An NSP is a processor comprising an artificial neural network configured to process data. For example, the NSP may process tracked head pose information to predict one or more positions of a head pose. The NSP may analyze the head movement of a user and employ a neural network to predict a starting head pose and an ending head pose of a user during a period of time in the future based on the analyzed head movement. The RSC engine may obtain a representation of optical distortion. The indication of the representation of optical distortion may include a representation of how a lens of a display may distort an image that is displayed through the lens. The representation of optical distortion may include a pincushion grid for LDC. The RSC engine may obtain the representation of optical distortion from a memory location, for example a memory of an HMD. The RSC engine may determine a sparse distortion grid based on the obtained indication of the predicted start head pose and the predicted end head pose and obtained representation of optical distortion. A sparse distortion grid may be a grid of vertices that map movement of a vertex from a planar rendered frame to a non-planar display. The RSC engine may generate a sparse distortion grid that is a transformed grid for both LDC and RSC. In some aspects, the RSC engine may determine the sparse distortion grid by determining a difference between distorted coordinates (based on movement between the predicted start head pose and the predicted end head pose) and uniform coordinates (based on the representation of optical distortion). Uniform coordinates are evenly distributed on a grid. Distorted coordinates are not evenly distributed on a grid. An RSC engine may map uniform coordinates corresponding to a rendered frame to distorted coordinates corresponding to a display to perform RSC on the rendered frame. The RSC engine may output, to a geometric correction engine (GCX), an indication of the determined sparse distortion grid. A GCX may be an apparatus that distorts a rendered frame for display. The GCX may distort each vertex of a grid map based on the determined sparse distortion grid. The CPU or a GPU of a display system may include the GCX. In other words, the CPU or the GPU of the display system may apply a determined sparse distortion grid to a rendered frame to reproject the rendered frame to perform both LDC and RSC to the rendered frame.

Particular aspects of the subject matter described in this disclosure can be implemented to realize one or more of the following potential advantages. In some examples, by using a raster scan correction engine to determine a raster scan correction instead of using a CPU, the described techniques can be used to reduce latency, power, and/or memory used to determine the raster scan correction. In some examples, by using a raster scan correction engine to determine a raster scan correction instead of using a GPU, the described techniques can be used to reduce power, and/or memory used to determine the raster scan correction.

The examples describe herein may refer to use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

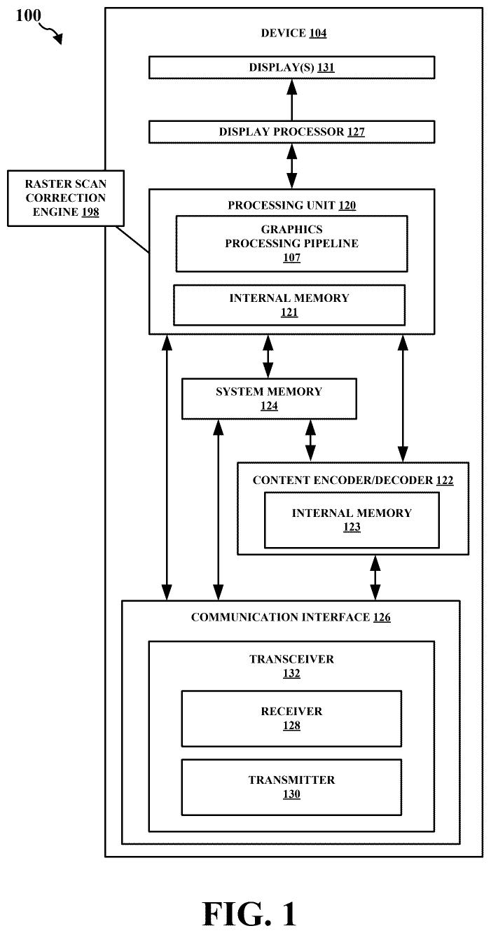

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or by a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors. A set of processors configured to perform a set of tasks may be configured to perform the set of tasks individually, or in any combination.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a raster scan correction engine 198 configured to obtain, from a tracking unit, an indication of a predicted start head pose and a predicted end head pose. The raster scan correction engine 198 may be configured to obtain a representation of optical distortion. The raster scan correction engine 198 may be configured to determine a sparse distortion grid based on the obtained indication of the predicted start head pose and the predicted end head pose and the obtained representation of optical distortion. The raster scan correction engine 198 may be configured to output, to a geometric correction engine (GCX), an indication of the determined sparse distortion grid. The raster scan correction engine 198 may include a coprocessor or a hardware accelerator to the processing unit 120. The raster scan correction engine 198 may have a direct path to the processing unit 120 to accelerate inefficient aspects of the processing unit 120, for example a generic CPU. Although the following description may be focused on graphics processing, the concepts described herein may be applicable to other similar processing techniques.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

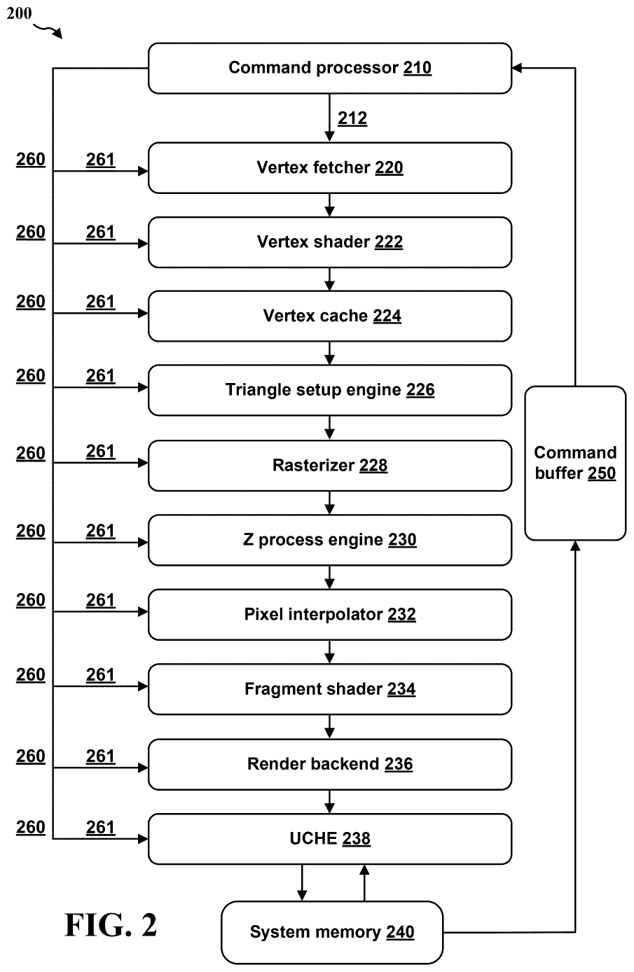

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call data packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

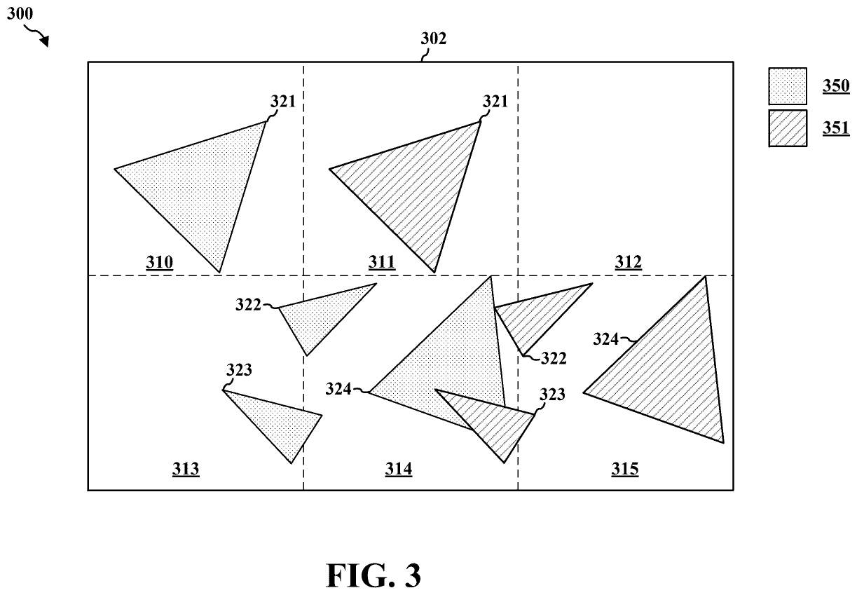

FIG. 3 illustrates image or surface 300, including multiple primitives divided into multiple bins in accordance with one or more techniques of this disclosure. As shown in FIG. 3, image or surface 300 includes area 302, which includes primitives 321, 322, 323, and 324. The primitives 321, 322, 323, and 324 are divided or placed into different bins, e.g., bins 310, 311, 312, 313, 314, and 315. FIG. 3 illustrates an example of tiled rendering using multiple viewpoints for the primitives 321-324. For instance, primitives 321-324 are in first viewpoint 350 and second viewpoint 351. As such, the GPU processing or rendering the image or surface 300 including area 302 can utilize multiple viewpoints or multi-view rendering.

As indicated herein, GPUs or graphics processors can use a tiled rendering architecture to reduce power consumption or save memory bandwidth. As further stated above, this rendering method can divide the scene into multiple bins, as well as include a visibility pass that identifies the triangles that are visible in each bin. Thus, in tiled rendering, a full screen can be divided into multiple bins or tiles. The scene can then be rendered multiple times, e.g., one or more times for each bin.

In aspects of graphics rendering, some graphics applications may render to a single target, i.e., a render target, one or more times. For instance, in graphics rendering, a frame buffer on a system memory may be updated multiple times. The frame buffer can be a portion of memory or random access memory (RAM), e.g., containing a bitmap or storage, to help store display data for a GPU. The frame buffer can also be a memory buffer containing a complete frame of data. Additionally, the frame buffer can be a logic buffer. In some aspects, updating the frame buffer can be performed in bin or tile rendering, where, as discussed above, a surface is divided into multiple bins or tiles and then each bin or tile can be separately rendered. Further, in tiled rendering, the frame buffer can be partitioned into multiple bins or tiles.

As indicated herein, in some aspects, such as in bin or tiled rendering architecture, frame buffers can have data stored or written to them repeatedly, e.g., when rendering from different types of memory. This can be referred to as resolving and unresolving the frame buffer or system memory. For example, when storing or writing to one frame buffer and then switching to another frame buffer, the data or information on the frame buffer can be resolved from the GMEM at the GPU to the system memory, i.e., memory in the double data rate (DDR) RAM or dynamic RAM (DRAM).

In some aspects, the system memory can also be system-on-chip (SoC) memory or another chip-based memory to store data or information, e.g., on a device or smart phone. The system memory can also be physical data storage that is shared by the CPU and/or the GPU. In some aspects, the system memory can be a DRAM chip, e.g., on a device or smart phone. Accordingly, SoC memory can be a chip-based manner in which to store data.

In some aspects, the GMEM can be on-chip memory at the GPU, which can be implemented by static RAM (SRAM). Additionally, GMEM can be stored on a device, e.g., a smart phone. As indicated herein, data or information can be transferred between the system memory or DRAM and the GMEM, e.g., at a device. In some aspects, the system memory or DRAM can be at the CPU or GPU. Additionally, data can be stored at the DDR or DRAM. In some aspects, such as in bin or tiled rendering, a small portion of the memory can be stored at the GPU, e.g., at the GMEM. In some instances, storing data at the GMEM may utilize a larger processing workload and/or consume more power compared to storing data at the frame buffer or system memory.

In some aspects, a rolling display and head movements of a user may distort a view of an image displayed on an HMD. An RSC engine may be used to account for such distortion, for example by performing a uniform correction on each row of a scan, proportional to a uniform speed of a head movement. At the start of the scan, the RSC engine may not apply any rotation, and at the end of the scan, the RSC engine may apply rotation to the last row of the scan proportion to the speed of the head movement. In order to perform LDC, a GCX may use a sparse grid map to map a rectangular uniform grid to a pincushion grid. An RSC engine may also apply RSC to the grid map to account for head movements and rolling display.

While an RSC may be implemented on a CPU, a digital signal processor (DSP) or a GPU, it may be more efficient to implement RSC via a separate co-processor, such as an RSC engine. The RSC engine may have low power, as the RSC engine may be deployed on an augmented reality (AR) or virtual reality (VR) glasses system. The RSC engine may be a co-processor that uses a small surface area. The RSC engine may have high compute power. The RSC engine may have a high throughput used to update a grid map for every frame displayed to an HMD. The RSC engine may have low latency. The RSC engine may be flexible to conform to different displays and layers. The RSC engine may be configured to synchronize with other display accelerators and hardware accelerators.

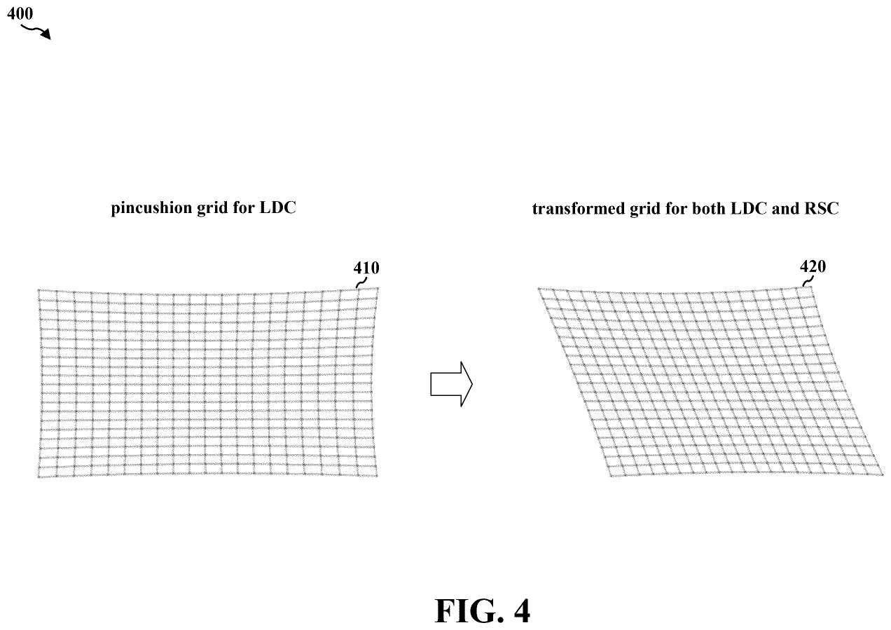

FIG. 4 is a diagram 400 illustrating a representation of an optical distortion 410 that may be processed by an RSC engine, such as the raster scan correction engine 198 of FIG. 1, to generate a sparse distortion grid 420. The representation of the optical distortion 410 may be a pincushion grid that describes how the lens of a display distorts an image when viewed by a user. The representation of the optical distortion 410 may be used for LDC of an image, for example by pre-distorting an image using the grid so that when the pre-distorted image is shown through the lens, the user will see the image as being straight and not bent. Each of the vertices of the representation of the optical distortion 410 may be mapped to a vertex on a grid with regularly spaced vertices that are not bent relative to one another in a straight row or column in the straight grid.

When a user rotates their head from one side to another side, an RSC engine may compensate for the movement by distorting the representation of the optical distortion 410 to compensate for the head movement. Without such compensation, the image may look askew to the user as the user moves their head from side to side. In the sparse distortion grid 420, vertices may be shifted from left to right, as the user turns their head from left to right. In other words, the sparse distortion grid 420 may be an inverse mapping from output pixel coordinates to pixel coordinates of the input image. The sparse distortion grid 420 may be a transformed grid that may be used on an input image to perform both LDC and RSC simultaneously. A GCX may apply the sparse distortion grid 420 to an input image to warp the image for both LDC and RSC. In other words, the GCX may use the sparse distortion grid 420 to compensate for both lens distortion and display raster scan errors. The GCX may use the sparse grid as an inverse mapping from the output pixel coordinates to the pixel coordinates of the input image. In some aspects, after applying the sparse distortion grid 420, the GCX may perform reprojection and composition on the transformed image. The topmost edge of the sparse distortion grid 420 may correspond with the predicted start head pose, and may be referred to a set of start coordinates corresponding to the predicted start head pose. The bottommost edge of the sparse distortion grid 420 may correspond with the predicted end head pose, and may be referred to as a set of distorted coordinates corresponding to the predicted end head pose.

In some aspects, the RSC engine may update the sparse distortion grid 420 per frame, for each color, and/or for each eye based on the head movement of the user. Each vertex of the sparse distortion grid 420 may be rotated proportional to its distance value relative to the start of the scan, for example along a y-axis on a uniform grid. In some aspects, the RSC engine may represent a sparse distortion grid as a set of differences between the optical distortion 410 and the sparse distortion grid 420 to save on memory used to store the sparse distortion grid. For example, the RSC engine may use 20 bits to store the sparse distortion grid 420, but may use 16 bits to store the difference between the sparse distortion grid 420 and the optical distortion 410.

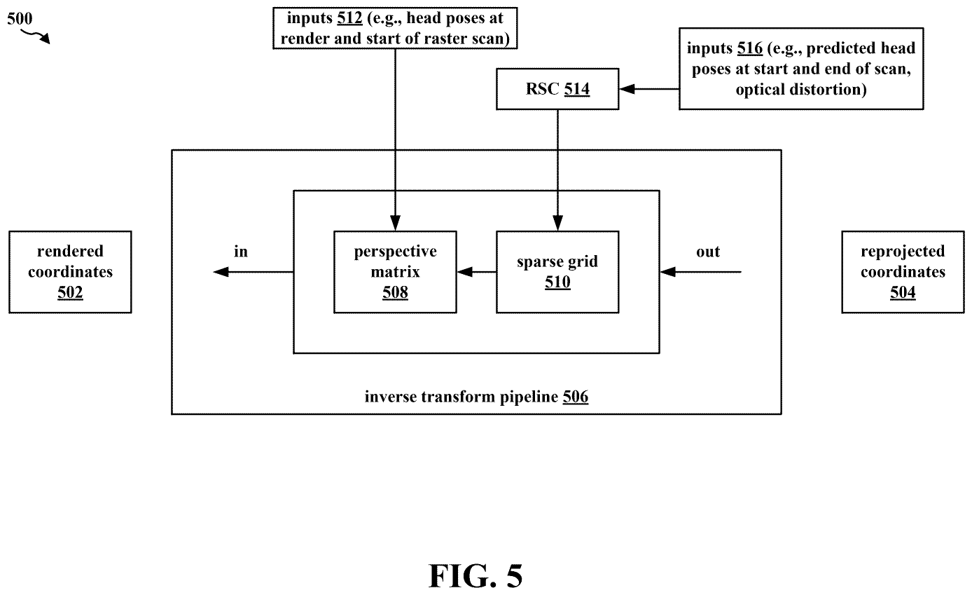

FIG. 5 is a diagram 500 of an inverse transform pipeline 506. The diagram 500 illustrates a representation of how a GCX may calculate a mapping from output pixel coordinates, also referred to as reprojected coordinates, to input pixel coordinates, also referred to as the rendered coordinates. In other words, the GCX mapping may be applied to a rendered frame to perform reprojection on the rendered frame. The GCX may obtain the color for each reprojected coordinate from the rendered coordinates using the inverse mapping. An RSC engine 514 may obtain a set of inputs 516 from a tracking unit, for example a 6DOF tracking unit or an NSP. The set of inputs 516 may include an indication of a predicted start head pose, an indication of a predicted end head pose, and/or a representation of an optical distortion. The indication of the predicted start head pose may indicate a position and orientation of a head of a user in 6DOF with a first associated time stamp. The indication of the predicted end head pose may indicate a position and orientation of a head of a user in 6DOF with a second associated time stamp, where the first associated time stamp is before the second associated time stamp. The representation of the optical distortion may include the representation of the optical distortion 410 in FIG. 4. The RSC engine 514 may then determine a sparse distortion grid based on the set of inputs 516, for example the sparse distortion grid 420 in FIG. 4. The inverse transform pipeline 506 may obtain the sparse distortion grid from the RSC engine 514 as the sparse grid 510.

The inverse transform pipeline 506 may apply the sparse grid 510 to the set of inputs 512, to generate a perspective matrix 508 based on the set of inputs 512. The RSC engine 514 may obtain the set of inputs 512 as a set of predicted head poses generated by a 6DOF tracking unit. A GCX may use the perspective matrix 508 to reproject an input image from a rendered head pose to the start of a raster scan head pose. The set of inputs 512 may include an indication of a predicted head pose of a user at a render time, which may be correlated with a predicted head pose from the set of inputs 516. The set of inputs 512 may include an indication of a predicted head pose of a user at the start of a raster scan, which may be correlated with a predicted head pose from the set of inputs 516. The inverse transform pipeline 506 may apply the perspective matrix 508 to the set of reprojected coordinates 504 to obtain a set of rendered coordinates 502, which may be used to transform an input image for a display to account for reprojection from render head pose to start of raster scan head pose, LDC and RSC at the display.

In some aspects, the RSC engine 514 may store the generated sparse grid using absolute values. In other aspects, the RSC engine 514 may store the generated sparse grid as a difference between the distorted and uniform coordinates. Storing the generated sparse grid as the difference between distorted and uniform coordinates may reduce the memory used to both store and transmit the sparse grid, reducing resource use. For example, an absolute value of a sparse grid may use 20 bit (20b) fixed point values, where a differential value of a sparse grid may use 16b fixed point values, saving 25% of memory storage and bandwidth resources.

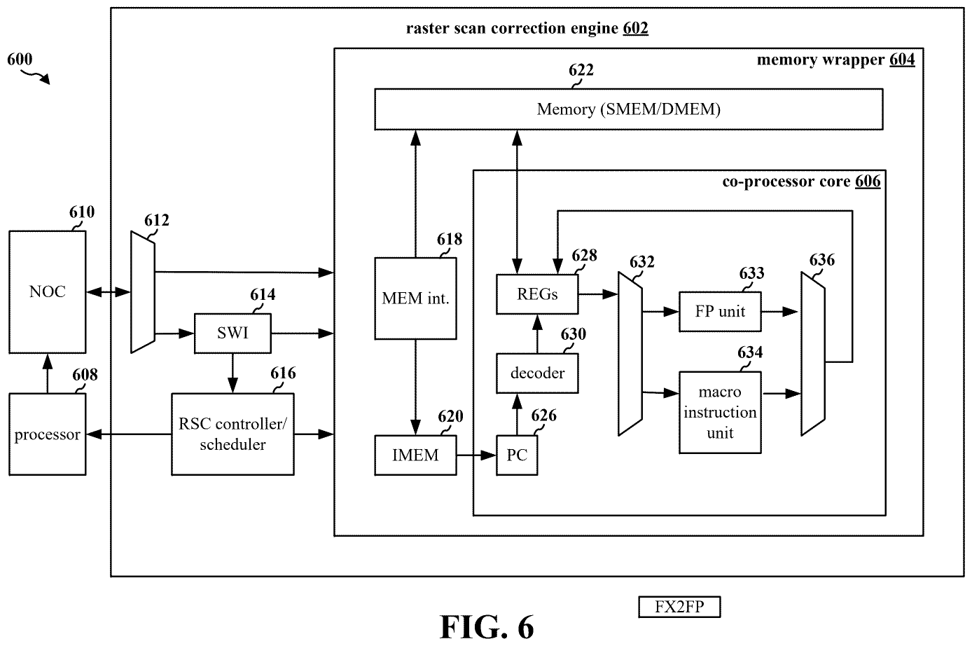

FIG. 6 includes a diagram 600 of a raster scan correction engine 602, in accordance with one or more techniques of this disclosure. The raster scan correction engine 602 may be, for example, a coprocessor or a hardware accelerator for a control engine, such as a CPU or a DSP. Here, the control engine is represented by a processor 608, which may have a direct path to the raster scan correction engine 602 via a bidirectional static random-access memory (SRAM) network unit (NU) interface between the network and operations controller (NOC) 610, shown as communicating with the MUX 612, and via an interrupt channel, shown as communicating with the RSC controller/scheduler 616. The processor 608 may be any suitable control engine, for example a CPU or a DSP. The processor 608 may be any low-power processor tightly coupled to the raster scan correction engine 602 to minimize overhead communication costs.

The raster scan correction engine 602 may receive a set of commands from the processor 608 via the NOC 610. In response to receiving the set of commands from the processor 608, the raster scan correction engine 602 may execute FP operations via the FP unit 633 or RSC-dedicated operations via a macro instruction unit 634. The MUX 612 may direct instructions received from the NOC 610 to the memory wrapper 604 of the raster scan correction engine 602 via an SRAM network interface unit (NIU) interface, or to a software interface (SWI) 614, which may feed each command from the NOC 610 to the memory wrapper 604 via an SWI register. The SWI 614 may also provide instructions to the RSC controller/scheduler 616, which may provide feedback interrupts back to the processor 608, and may provide scheduling signals to the memory wrapper 604, for example start commands, control signal commands, and program counter (PC) reset commands.

The memory wrapper 604 may act as a memory wrapper for the raster scan correction engine 602, including a memory interface unit 618, which loads the instructions into the memory 622, which may include a set of shared memory (SMEM) and a set of data memory (DMEM). The SMEM may be used for static data that is loaded at run time and is read during the RSC process, while the DMEM may be used for dynamic data that is computed and changes during the RSC process to determine the resultant sparse distortion grid.

Instructions from the IMEM 620 may be provided to a PC 626 of the co-processor core 606, which may be decoded sequentially address-by-address via a decoder 630, which may process commands to perform operations on data variables stored in the set of registers 628. The MUX 632 may route data variables through the FP unit 633 for an FP or integer operation (e.g., addition, multiplication), or through the macro instruction unit 634 for a set of batch operations. The DEMUX 636 may then direct results of the operations to the set of registers 628, which may selectively be stored in the memory 622 for output to a graphics engine, such as a GCX or a GPU.

The raster scan correction engine 602 may be a dedicated hardware unit that is configured to perform RSC for a control engine, such as a CPU or a DSP. A dedicated hardware unit has the macro instruction unit 634 having a set of batch operations for RSC that may be performed in response to a single command, for example a command to perform a series of ten FP operations common to RSC.

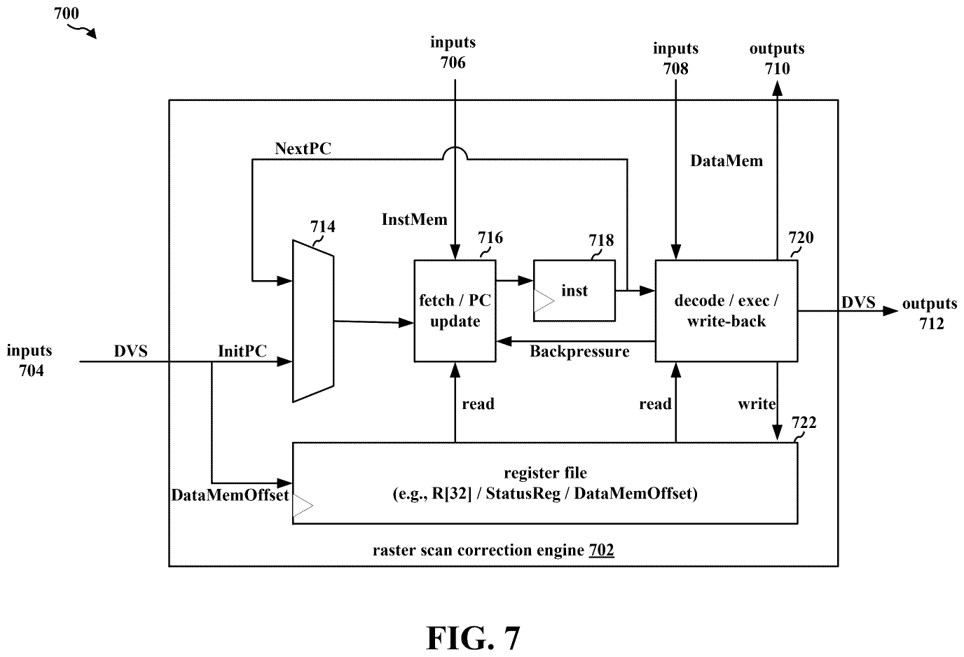

FIG. 7 is a diagram 700 illustrating data logic of a raster scan correction engine 702, such as the raster scan correction engine 602 in FIG. 6, in accordance with one or more techniques of this disclosure. A control engine, such as a CPU, may transit a set of inputs 704, a set of inputs 706, and a set of inputs 708 to the raster scan correction engine 702, and may receive a set of outputs 710 and a set of outputs 712. The set of inputs 704 may include a set of data virtualization service (DVS) inputs that are routed as an initial program counter (InitPC) to a MUX 714, and an offset value (DataMemOffset) to a register file 722. The register file 722 may store register data (e.g., 32b registers), status register data, and memory offset data, and may be accessed by the instruction block 716 and the decode block 720. The set of inputs 706 may include a set of instructions for the raster scan correction engine 702, for example, indicating which FP operations to perform, or which RSC macros to perform. The raster scan correction engine 702 may load the set of instructions to the instruction block 716, which may fetch program instructions based on instructions read from the register file 722. The instruction incrementor 718 may increment the PC of the instruction to the MUX 714, which may determine whether to proceed to the next instruction. The set of inputs 708 may include a set of inputs that read from the data memory (e.g., the predicted start head pose, the predicted end head pose, the representation of optical distortion) and the set of outputs 710 may include as set of outputs that write to the data memory (e.g., the sparse distortion grid). The set of outputs 712 may include a set of DVS outputs that indicate a status of the RSC process at the raster scan correction engine 702.

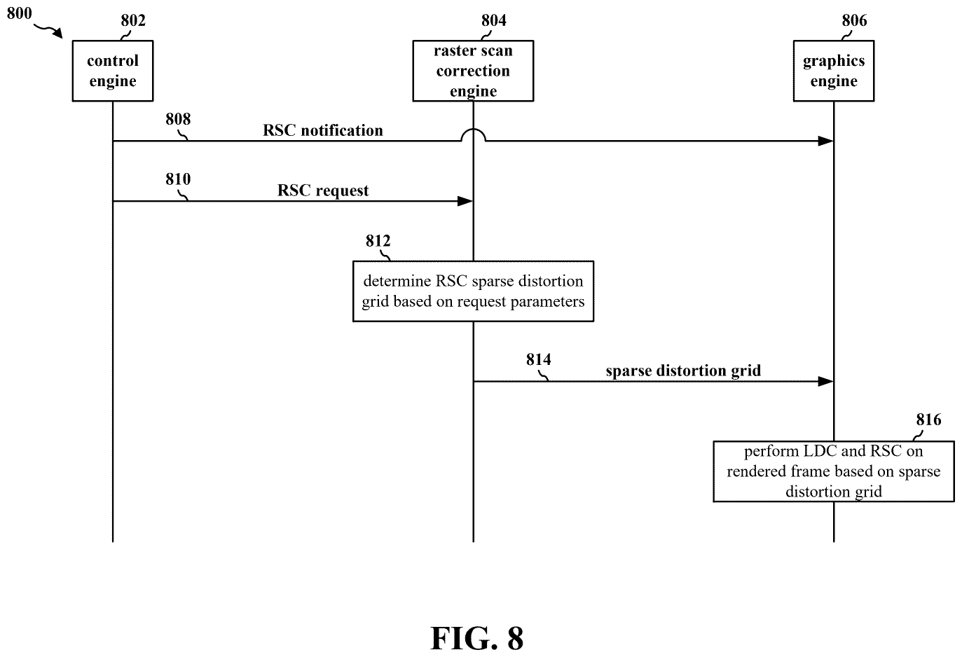

FIG. 8 is a call flow diagram 800 illustrating example communications between a control engine 802, a raster scan correction engine 804, and a graphics engine 806, in accordance with one or more techniques of this disclosure. The control engine 802 may be, for example, a CPU or a DSP. The graphics engine 806 may be, for example, a GCX or a GPU configured to perform distortion on an object based on an output raster scan correction. The raster scan correction engine 804 may be a co-processor or a hardware accelerator that has a direct path to the control engine 802 to minimize communications latency.

The control engine 802 may output an indication 808 of a distortion notification to the graphics engine 806. The graphics engine 806 may receive the indication 808 of the RSC notification from the control engine 802. The indication 808 of the RSC notification may include a rendered frame and an instruction to perform LDC and RSC on the rendered frame based on an output sparse distortion grid received from the raster scan correction engine 804. In response to receiving the indication 808 of the RSC notification from the control engine 802, the graphics engine 806 may wait for an indication of a sparse distortion grid to be received from the raster scan correction engine 804.

The control engine 802 may output an indication 810 of an RSC request to the raster scan correction engine 804. The raster scan correction engine 804 may obtain the indication 810 of the RSC request from the raster scan correction engine 804. The indication 810 of the RSC request may include an indication of a predicted start and end head pose, and a representation of optical distortion. In some aspects, the representation of optical distortion may be a memory address that may be used by the raster scan correction engine 804 to retrieve a pincushion grid for LDC. The indication 810 of the RSC request may include a set of raster scan correction instructions, for example a set of FP operations and a set of macros to perform.

At 812, the raster scan correction engine 804 may determine a sparse distortion grid based on the request parameters indicated by the indication 810 of the RSC request. The raster scan correction engine 804 may output an indication 814 of the sparse distortion grid to the graphics engine 806. The indication may be a difference between a set of distorted coordinates and a set of uniform coordinates, which may minimize the resources used to store and transmit the grid. The graphics engine 806 may obtain the indication 814 of the sparse distortion grid from the raster scan correction engine 804. At 816, the graphics engine 806 may perform LDC and RSC on a rendered frame based on the sparse distortion grid, for example by shifting coordinates along a grid based on differential values of the sparse distortion grid.

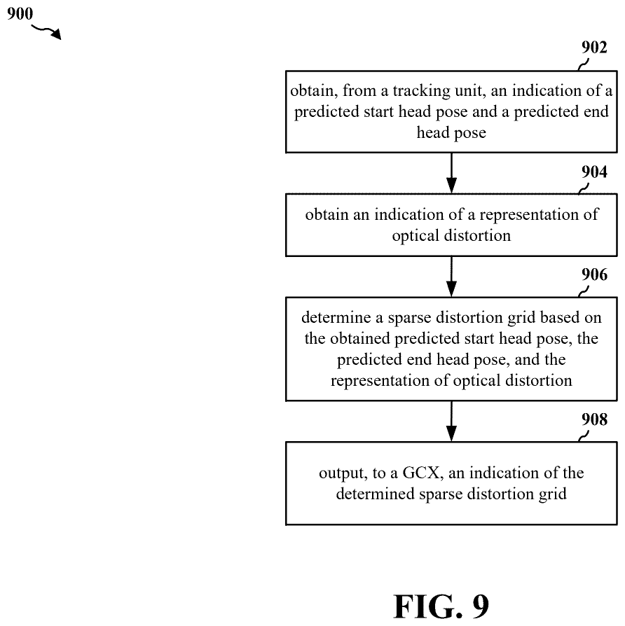

FIG. 9 is a flowchart 900 of an example method of graphics processing in accordance with one or more techniques of this disclosure. The method may be performed by an apparatus, such as an apparatus for graphics processing, a coprocessor, a hardware accelerator, a GPU, a CPU, a DPS, an RSC engine, a wireless communication device, and the like, as used in connection with the aspects of FIGS. 1-8.

At 902, the apparatus may obtain, from a tracking unit, an indication of a predicted start head pose and a predicted end head pose. For example, referring to FIG. 8, the raster scan correction engine 804 may obtain, from a tracking unit, an indication of a predicted start head pose and a predicted end head pose.

At 904, the apparatus may obtain an indication of a representation of optical distortion. For example, referring to FIG. 8, the raster scan correction engine 804 may obtain an indication of a representation of optical distortion.

At 906, the apparatus may determine a sparse distortion grid based on the obtained predicted start head pose, the predicted end head pose, and the representation of optical distortion. For example, referring to FIG. 8, the raster scan correction engine 804 may determine a sparse distortion grid based on the obtained predicted start head pose, the predicted end head pose, and the representation of optical distortion.

At 908, the apparatus may output, to a GCX, an indication of the determined sparse distortion grid. For example, referring to FIG. 8, the raster scan correction engine 804 may output, to a GCX, an indication of the determined sparse distortion grid.

In configurations, a method or an apparatus for graphics processing is provided. The apparatus may be a GPU, a CPU, an RSC engine, or some other processor, or co-processor, that may perform graphics processing. In aspects, the apparatus may be the processing unit 120 within the device 104, or may be some other hardware within the device 104 or another device. The apparatus may include means for obtaining, from a tracking unit, an indication of a predicted start head pose and a predicted end head pose. The apparatus may further include means for obtaining a representation of optical distortion. The apparatus may further include means for determining a sparse distortion grid based on the obtained indication of the predicted start head pose and the predicted end head pose and the obtained representation of optical distortion. The apparatus may further include means for outputting, to a GCX, an indication of the determined sparse distortion grid. The means may include the raster scan correction engine 198 in FIG. 1.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.
Aspect 1 is a method of graphics processing, comprising: obtaining, from a tracking unit, an indication of a predicted start head pose and a predicted end head pose; obtaining an indication of a representation of optical distortion; determining a sparse distortion grid based on the obtained predicted start head pose, the predicted end head pose, and the representation of optical distortion; and outputting, to a geometric correction engine (GCX), an indication of the determined sparse distortion grid.
Aspect 2 is the method of aspect 1, wherein the tracking unit comprises a six degrees of freedom (6DOF) tracking unit.
Aspect 3 is the method of aspect 2, wherein the tracking unit comprises a neural signal processor (NSP).
Aspect 4 is the method of aspect 1, wherein obtaining the indication of representation of optical distortion comprises: obtaining the indication of representation of optical distortion from a memory location at the apparatus. In other words, an HMD may save an indication of optical distortion, for example a pincushion grid for LDC, on a cache of the HMD. The apparatus may obtain the pincushion grid from the cache of the HMD, which may be used as a basis for generating the representation of optical distortion for raster scan correction.
Aspect 5 is the method of aspect 4, further comprising: determining the optical distortion during a calibration of a head-mounted display (HMD). In some aspects, the method may include storing a representation of the optical distortion on the memory location at the apparatus after the determination of the optical distortion.
Aspect 6 is the method of aspect 1, wherein the representation of optical distortion comprises a display projection matrix.
Aspect 7 is the method of aspect 1, wherein the sparse distortion grid comprises a reprojection matrix.
Aspect 8 is the method of aspect 1, wherein the sparse distortion grid comprises a set of differences between a set of start coordinates corresponding to the predicted start head pose and a set of distorted coordinates corresponding to the predicted end head pose.
Aspect 9 is the method of aspect 1, wherein the geometric correction engine comprises a set of hardened circuits to perform raster scan correction based on the determined sparse distortion grid.
Aspect 10 is the method of aspect 1, wherein determining the sparse distortion grid based on the obtained predicted start head pose, the predicted end head pose, and the representation of optical distortion comprises: determining, via a dedicated hardware unit of a system on a chip (SOC), the sparse distortion grid based on the obtained predicted start head pose, the predicted end head pose, and the representation of optical distortion.
Aspect 11 is the method of aspect 1, wherein obtaining, from the tracking unit, the indication of the predicted start head pose and the predicted end head pose comprises: obtaining, from a central processing unit (CPU) comprising the tracking unit, the indication of the predicted start head pose and the predicted end head pose.
Aspect 12 is the method of aspect 1, wherein outputting, to a GCX, the indication of the determined sparse distortion grid comprises: outputting, to a graphics processing unit (GPU) comprising the GCX, the indication of the determined sparse distortion grid.
Aspect 13 is the method of aspect 1, further comprising: determining a reprojection matrix based on the indication of the determined sparse distortion grid; and distorting, via the GCX, each vertex of a grid map based on the determined reprojection matrix.
Aspect 14 is an apparatus for graphics processing including at least one processor coupled to a memory and configured to implement a method as in any of aspects 1-13.
Aspect 15 may be combined with aspect 14 and includes that the apparatus is a wireless communication device.
Aspect 16 is an apparatus for graphics processing including means for implementing a method as in any of aspects 1-13.
Aspect 17 is a computer-readable medium (e.g., a non-transitory computer-readable medium) storing computer executable code, the code when executed by at least one processor causes the at least one processor to implement a method as in any of aspects 1-13.

Various aspects have been described herein. These and other aspects are within the scope of the following claims.

What is claimed is:

1. An apparatus for graphics processing, comprising:
a memory; and
a processor coupled to the memory and, based on information stored in the memory, the processor is configured to:
obtain, from a tracking unit, an indication of a predicted start head pose and a predicted end head pose;
obtain a representation of optical distortion;
determine a sparse distortion grid based on the obtained indication of the predicted start head pose and the predicted end head pose and the obtained representation of optical distortion; and
output, to a geometric correction engine (GCX), an indication of the determined sparse distortion grid.

2. The apparatus of claim 1, wherein the tracking unit comprises a six degrees of freedom (6DOF) tracking unit.

3. The apparatus of claim 2, wherein the tracking unit comprises a neural signal processor (NSP).

4. The apparatus of claim 1, wherein, to obtain the representation of optical distortion, the processor is configured to:
obtain the representation of optical distortion from a memory location at the apparatus.

5. The apparatus of claim 4, wherein the processor is further configured to:
determine the optical distortion during a calibration of a head-mounted display (HMD).

6. The apparatus of claim 1, wherein the representation of optical distortion comprises a display projection matrix.

7. The apparatus of claim 1, wherein the sparse distortion grid comprises a reprojection matrix.

8. The apparatus of claim 1, wherein the sparse distortion grid comprises a set of differences between a set of start coordinates corresponding to the predicted start head pose and a set of distorted coordinates corresponding to the predicted end head pose.

9. The apparatus of claim 1, wherein the geometric correction engine comprises a set of hardened circuits to perform raster scan correction based on the determined sparse distortion grid.

10. The apparatus of claim 1, wherein, to determine the sparse distortion grid based on the obtained indication of the predicted start head pose and the predicted end head pose and the obtained representation of optical distortion, the processor is configured to:
determine, via a dedicated hardware unit of a system on a chip (SOC), the sparse distortion grid based on the obtained indication of the predicted start head pose and the predicted end head pose and the obtained representation of optical distortion.

11. The apparatus of claim 1, wherein, to obtain, from the tracking unit, the indication of the predicted start head pose and the predicted end head pose, the processor is configured to:
obtain, from a central processing unit (CPU) comprising the tracking unit, the indication of the predicted start head pose and the predicted end head pose.

12. The apparatus of claim 1, wherein, to output, to the GCX, the indication of the determined sparse distortion grid, the processor is configured to:
output, to a graphics processing unit (GPU) comprising the GCX, the indication of the determined sparse distortion grid.

13. The apparatus of claim 1, wherein the processor is further configured to:
determine a reprojection matrix based on the indication of the determined sparse distortion grid; and
distort, via the GCX, each vertex of a grid map based on the determined reprojection matrix.

14. The apparatus of claim 1, wherein the apparatus comprises a wireless communication device.

15. A method of graphics processing, comprising:
obtaining, from a tracking unit, an indication of a predicted start head pose and a predicted end head pose;
obtaining a representation of optical distortion;
determining a sparse distortion grid based on the obtained indication of the predicted start head pose and the predicted end head pose and the obtained representation of optical distortion; and
outputting, to a geometric correction engine (GCX), an indication of the determined sparse distortion grid.

16. The method of claim 15, wherein determining the sparse distortion grid based on the obtained indication of the predicted start head pose and the predicted end head pose and the obtained representation of optical distortion comprises:
determining, via a dedicated hardware unit of a system on a chip (SOC), the sparse distortion grid based on the obtained indication of the predicted start head pose and the predicted end head pose and the obtained representation of optical distortion.

17. The method of claim 15, wherein obtaining, from the tracking unit, the indication of the predicted start head pose and the predicted end head pose comprises:
obtaining, from a central processing unit (CPU) comprising the tracking unit, the indication of the predicted start head pose and the predicted end head pose.

18. The method of claim 15, wherein outputting, to the GCX, the indication of the determined sparse distortion grid comprises:
outputting, to a graphics processing unit (GPU) comprising the GCX, the indication of the determined sparse distortion grid.

19. The method of claim 15, further comprising:
determining a reprojection matrix based on the indication of the determined sparse distortion grid; and
distorting, via the GCX, each vertex of a grid map based on the determined reprojection matrix.

20. A computer-readable medium storing computer executable code, the code when executed by a processor, causes the processor to:
obtain, from a tracking unit, an indication of a predicted start head pose and a predicted end head pose;
obtain a representation of optical distortion;
determine a sparse distortion grid based on the obtained indication of the predicted start head pose and the predicted end head pose and the obtained representation of optical distortion; and
output, to a geometric correction engine (GCX), an indication of the determined sparse distortion grid.
